(19) United States
(12) Patent Application Publication
(10) Pub. No.: US 2011/0221566 A1
(43) Pub. Date: Sep. 15, 2011

(54) Authenticating device with wireless directional radiation

(76) Inventor: Douglas Kozlay, Timonium, MD (US)

(21) Appl. No.: 11/051,673

(22) Filed: Feb. 4, 2005

(51) Int. Cl. G06F 7/04

(52) U.S. Cl. 340/5.53; 340/1.1; 340/5.51; 340/5.52

(57) ABSTRACT

A directional, wireless, user-authenticating electronic token is disclosed. The token is embedded as an integrated system (generally, within a protective electronic enclosure). Typically the present invention includes a fingerprint sensor, a processor, a power source, a token transceiver and antenna, and orientation indicia. The antenna propagates highly directional signals. This allows users to orient (i.e., “aim”) token signals toward intended transceivers (POS machines, doors, computers, etc.), while reducing risks of transacting with “unintended” transceivers outside the aimed beam. The present invention offers an improved design for electronic wireless hardware tokens: providing versatile, secure, directional, wireless, user-authenticating devices (e.g., advanced ID cards, smartcards, hybrid cards, dongles, etc.). Such devices reduce risk of unintended emissions (i.e., signals radiating in the direction of unintended transceivers). As an optional aid to pointing the device in the direction of an intended transceiver, a narrow guiding light beam can be included as a target designator.

### BACKGROUND

1. Field of the Invention

The field of the invention is wireless devices and wireless user-authenticating devices, more particularly, authenticating devices with highly directional signals and highly directional signal output lobes (footprints) for optimizing wireless message transmission in the direction of intended receivers only.

2. Related Art

There are a variety of “authenticating devices” in the art. Notwithstanding, the inventor has not found any other wireless authenticating devices with highly directional antenna footprints and other features and benefits of the present invention, comparable to the present invention.

There are a variety of “hardware tokens” are known in the art. Typically, hardware tokens use a reduced size form factor physical enclosure, such as a USB dongle, a smartcard or other card, calculator size tokens, etc. Examples of radio frequency “hardware tokens” are products currently made and/or sold by HID; Exxon-Mobil SPEEDPASS®; etc. Generally, such hardware tokens are also directly bundled with enabling software products and they are provided as integrated and/or as embedded systems. Integrated systems and hardware tokens function together, thereby providing (often vendor specific) control and/or security solutions.

Thus, the use of simple user-authenticating electronic “tokens”—e.g., smartcards and authenticating tokens, handheld “dongles” (and the like) for authenticating “enrolled and authorized” users and/or for performing secured transactions—are known in the art. Some of these devices are wirelessly operated in proximity to transceiver devices to authenticate and confirm the identity of enrolled authorized users (i.e., user token holders). In theory (and in limited practice) such devices can also operate to transfer account information needed prerequisite to completion of transaction(s), operate to open doors, operate to access computers, vaults, and other controlled and secured resources. In summary, existing user-authenticating electronic tokens are employed to help determine and communicate the extent of enrolled and authorized token users' access privileges. The main challenge all these products have, is that most are neither wireless nor are the wireless products generally directional wireless products comparable in features and flexibility that are hallmarks of the present invention.

In summary, while there are user-authenticating products and wireless products known in the art, the inventor finds no directional, wireless, user-authenticating electronic tokens comparable to the present invention. Thus, accordingly, there appears to be a need in the art for wireless electronic token products with directional, wireless, user-authenticating capabilities in a hardware token with a small form factor size.

Necessity of the Invention:

Wireless, directional, user-authenticating electronic “tokens”—e.g., smartcards, handheld “dongles”, and the like—for wirelessly authenticating users and/or performing secured transactions—appears to address unfulfilled needs and widely perceived needs of information technology consumers.

The token devices of the present invention can be wirelessly operated in proximity to a transceiver device to confirm the identity of the token holder and (depending on configuration), such devices can also be operated to transfer account information needed to complete transaction(s) and/or determine the token holder's access privileges. No comparable products appear to exist in the market.

As technology improves, the transmission range of personal identifying tokens such as contactless cards and RFID tags has grown from a few centimeters to more than one meter or greater, creating a hazard that a wireless transaction may radiate from the token's antenna and propagate in an unintended direction. Such “unintentional misdirection” from the wireless token, becomes an exposure; i.e., an unintentional signal misdirection allows a transmission to possibly be read by an unintended transceiver (receiver and/or transceiver). Such “misdirection” could result, e.g., in an erroneous transaction at another legitimate transceiver. Or, e.g., the misdirection could result in a false or unintended transaction with a “rogue transceiver”, which amounts to theft or worse. Additionally, in access control applications, the token holder may inadvertently or deliberately gain access to a wrong computing device (e.g., because the wireless signal was sent in many or all directions).

Accordingly, it appears there's a need in the art for a wireless token that possesses the property of highly directional signal transmission such that the token holder can aim or point their wireless token at an intended transceiver or receiver (e.g., at a user's intended terminal, doorway, lock, vault, etc.) and gain access to that intended target receiver device—and/or transact business with that intended device—and only with that intended device.

In summary, while there are user-authenticating products known in the art and wireless “token” products known in the art, there seems to be no highly directional, wireless, user-authenticating electronic tokens comparable to those of the present invention. Thus, there appears to be a need in the art for the secure and accurate present invention, a wireless electronic token product with highly directional, wireless, user-authenticating capabilities in a hardware token with a small form factor size.

### OBJECTS OF THE INVENTION

Accordingly, it is one primary object of the present invention to provide a wireless directional, user-authenticating “electronic token” that can be deliberately pointed only in the direction of (i.e., “aimed” at) intended receiver(s). Due to its' highly directional antenna radiation propagation pattern (given its' narrow-lobed, focused signal energy) the wireless user-authenticating token of the present invention, transmits little or no usable signal to unintended receivers, thereby increasing security and accuracy, while decreasing risks of unintended transmissions.

It is another primary object, to provide one or more token-aiming indicators and/or indicia upon the exterior of the token of the present invention (e.g., at least one of an arrow, a pointer, or other distinctive visual indicia such as a LED or a focused light beam) to help a user optimally “aim” and orient the token accurately only upon intended receiver or transceiver. The token-aiming indicator(s) tell the user, the most effective directional orientation of the token, thereby maximizing optimum intended transmission characteristics, while minimizing signal transmission to unintended receivers and transceivers. The benefits of this feature are that it enables users to more quickly and accurately aim their token properly; this feature also reduces frustration due to inaccurate pointing and failure to transmit and receive properly, and/or due to inadvertent communication with an unintended receiver.

It is another related object, to optionally provide a token-aiming “illuminator” (i.e., a “target designator”) to guide a user to optimally orient and aim the electronic token apparatus (essentially directly) at the intended receiver, along the path and plane of the token's maximum signal strength.

It is yet another object of the invention, to provide one or more “token actuators”—i.e., man/machine interfaces on the exterior of the token—e.g., push button(s) and/or other “token actuating” device(s). In versions of the present invention which have advanced user authentication security features—e.g., biometric sensor(s)—each prospective token user must be properly authenticated, before the token is enabled, actuated, and capable of transmitting to and intended receiver.

### SUMMARY OF THE INVENTION

The present invention is a wireless, user authenticating radio frequency token, a device that possesses the property of highly directional wireless transmission. Using the present invention, the wireless token holder can point the token at any specifically intended receiver situated at any access point where authentication is warranted (e.g., a terminal, doorway, gate, vault, or etc.). Successful user authentication allows the user to gain logical, physical, or other access (e.g., door access, computer access, transactional access, etc.), but only with the intended target receiver or transceiver.

Preferably, the token also provides one or more “token aiming” indicators—e.g., visual markings, and/or LEDs which flash when pointed in the direction of detected received carrier from an intended receiver, and/or other indicia or indicators—to help the user optimally aim and orient the token. When referring to such indicia, the user will always know how to approximately best aim the token toward the intended receiver.

The tokens of the present invention may optionally also employ an “illuminating beam” to help the user better aim the token in the direction of maximum antenna output (signal strength) propagation toward an intended receiver.

As an option, the token may be activated by a user's push or press of a button, a switch, or other authenticating sensor (e.g., a biometric device such as a fingerprint authenticating device, a voice authenticating device, an electrocardiogram authenticating device, etc.) with a processor that the user may employ to unlock its functions, once the token has been pointed in the right direction.

### BRIEF DESCRIPTION OF THE DRAWINGS AND REFERENCE NUMERALS

### BRIEF DESCRIPTION OF THE DRAWINGS

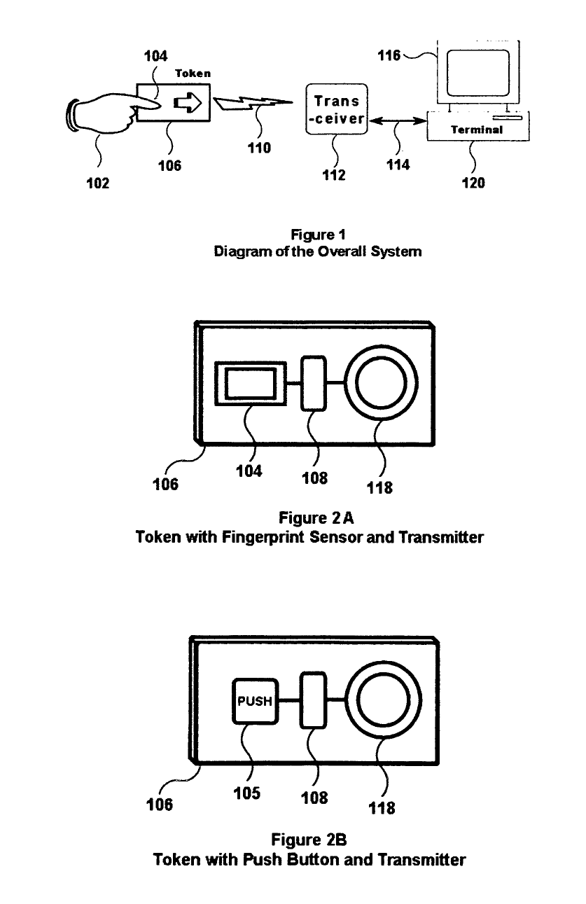

FIG. 1 depicts the system of the invention, from end to end.

FIG. 2A shows a token with fingerprint sensor and transmitter.

FIG. 2B shows a token with a push-button initiated transmitter.

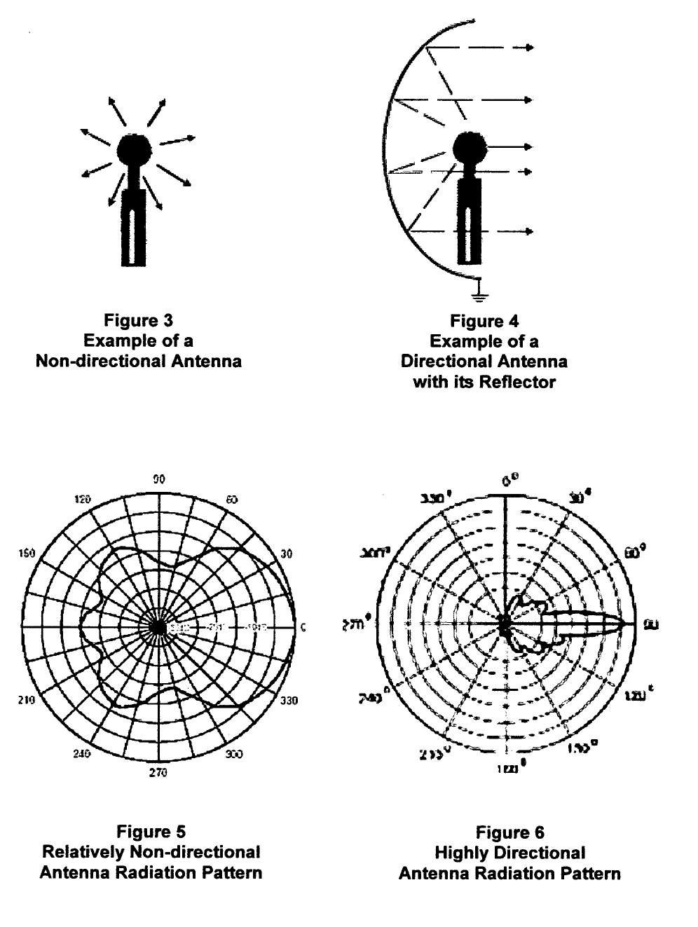

FIG. 3 illustrates a typical non-directional transmitter (an isotropic emitter).

FIG. 4 shows a typical directionally-oriented signal (a directed emitter).

FIG. 5 shows a typical non-directional signal emission pattern.

FIG. 6 shows a typical directionally-oriented signal emission pattern.

FIG. 7 illustrates a token-aiming, guiding illumination beam

FIG. 8 depicts transmitting to target with data path

FIG. 9 shows receiving with data path to illuminate ‘Carrier-Detect’ LED

### REFERENCE NUMERALS

102 User's hand with a finger being placed on its electronic fingerprint sensor

104 Electronic Fingerprint Sensor and Processor

106 Token in the form of a Card

108 Processor for Electronic Token

110 Radio Frequency transmission

112 RF Transceiver target

114 Communications path from transceiver 112 to terminal 116

116 Screen on terminal device (e.g., computer or other machine)

117 RF Transmitter (e.g., push button activated)

118 Highly Directional Antenna

119 RF Receiver (for detecting received signals from intended transceivers)

120 Point Of Sale machine (terminal, computer, intended transceiver, etc.)

122 Guiding Beam Light Source and light beam

123 Guiding Beam centerline on Radio Signal Wave Front 126

124 ‘Carrier-Detect’ LED

126 Radio Signal Wave Front

### DETAILED DESCRIPTION OF THE INVENTION

There are many possible versions of the present invention, depending on application needs and configurations implemented.

One version of the present invention can be activated only upon, and in response to a signal generated by a token transceiver.

Another version of the present invention can be activated only after successful completion of biometric authentication of a prospective user fingerprint on the electronic token, after the user presents their finger and the fingerprint sensor processor matches the inputted fingerprint in storage and determines the inputted fingerprint to represent the presence of an authorized and pre-enrolled user.

Yet another version of the present invention can be implemented with an actuator (e.g., a push-type button, or a switch) on the electronic token; in such a case, other security techniques can be used external to the electronic token to verify that the user is who they claim to be (not subjects of this application). The switch-actuated or push-button actuated versions of the invention can be considered “lower security” versions of the present invention, than the biometric fingerprint sensor versions. Additionally, when implemented, the push button (or plurality of push buttons) version of the present invention can be implemented in a manner such that a Personal Identification Number (PIN) can be used on the token, as one means for authentication of a prospective user of the token.

Referring now to FIG. 1, an overview of the present invention is shown. When initially enrolling to use the invention—but prior to “going into the field”—the user 102 is directed to enroll his/her fingerprint(s) into an authenticating device such as a biometric fingerprint sensor (e.g., a fingerprint sensor 104, coupled to a processor 108, as shown in FIG. 2A) aboard electronic token apparatus 106. In operation, after receiving a prompt (or at their own initiative): the user typically authenticates at least one pre-enrolled fingerprint to the fingerprint sensor aboard authenticator apparatus 106, as explained in more detail in FIG. 2A. Moving from left to right on FIG. 1, token 106 transmits to an intended receiver or transceiver 112. In this case, the intended receiver 112 is an interim stop enroute to display and terminal 114 (generally, after further processing).

FIG. 2A shows a closer view of electronic token apparatus 106. This drawing again shows a biometric fingerprint authentication version of the present invention. In operation, the user places one or more finger(s) on fingerprint sensor 104 and a graphic image of the fingerprint is captured as is well known in the art. When the user presents their fingerprint(s) to the fingerprint sensor 104 aboard token 106, processor 108 verifies the presented fingerprint(s) by comparison to its stored (internal and/or external) fingerprint template database of authorized enrolled users. (This fingerprint recognition technique is known in the art, e.g., as more fully articulated in U.S. Pat. No. 4,582,985 to Lofberg, and many others.) Assuming the user's presented fingerprint(s) “match”—subsequent to the user successfully completing the step of fingerprint authentication—processor 108 generates transmittable message data for transmission to the intended receiver—e.g., data indicating the identity of the user and/or results of user authentication.

Transmission of messages is effectuated by directional antenna 118. NB: The performance characteristics of antenna 118 can be set and/or varied (depending on details of implementation)—either at the factory and/or by users and/or application owners (based on installation-specific security policies, based on implemented capabilities, and other factors). Transmission of the highly directional signal is accomplished via RF transmitter 117.

Optimally, most message transmissions between any user and any intended receiver occur optimally, while the user is (approximately) aiming the token of the present invention in the direction of the intended receiver or transceiver. Since it is an objective of the invention to increase security and decrease risk by limiting or precluding radio dialogue (message communications) between electronic tokens and “unintended receivers”—depending on implementation/configuration details—some tokens may not properly communicate with (or may be terminated from communication with) intended receivers, if the enrolled authorized user fails to exercise sufficient care in aiming the electronic token of the present invention.

After the authorized enrolled user successfully completes biometric authentication, the token is enabled, and capable of receiving signals from its' intended target device or transceiver device. The devices (both the token and its' intended receiver) can then communicate in this way as long as necessary, i.e., until the transaction or access control function has been completed, ending transmission.

In the discussion of FIG. 2A above, one version of the process of authenticating an enrolled authorized user is discussed, using biometric fingerprint inputs. It is important to note, different biometric authentication versions of the present invention can be used—as can be observed from references to both biometric and non-biometric user authentication modalities additionally discussed herein.

Messages

Once biometric authentication is successfully completed, device messaging begins.

NB: Referring to FIG. 1 will assist understanding these Message examples. This example comprises a “2-way authenticated message exchange”:

Message sent from token 106 to the terminal 120:

[Header, Device Serial Number, Time Varying Parameter1, Checksum]

Message returned from terminal 120 to the token 106:

[Header, ENCRYPTED (Device Serial Number, Time Varying Parameter1), Time Varying Parameter2, Checksum](NB: Parameter1 decrypted and verified upon receipt before proceeding.)

Message sent from the token 106 to the terminal 120:

[Header, ENCRYPTED (Device Serial Number, Time Varying Parameter2), Checksum]

(NB: Parameter2 decrypted and verified upon receipt before proceeding.)

(NB: It is important to note, the above type of message exchange sequence is known in the art. Additional relevant data/information on messaging can be obtained from American National Standards Institute (ANSI) X9.19 message authentication standard. Additional basic definitions follow below.)

Definitions:

Header: A fixed data sequence to enable the recipient to recognize and synchronize with the message.

Device Serial Number: A unique number for each authenticator apparatus manufactured, which is installed at the factory or introduced at the time the device is issued to the user.

Authentication Result: An indication of the success or failure of a “biometric authentication of an authorized enrolled user” authentication event and optionally, an indication of the strength or certainty of that authentication (e.g., probability of positive match). NB: It is important to note, “biometric authentication” of a user, is different and separate of “cryptographic authentication” establishing the authenticity of a message, as defined in the ANSI X9.19 standard; i.e., it must be remembered that word “authentication” is used herein, in both these meanings, as should be obvious in explicit contexts that “authentication” is discussed.

Checksum: A CRC (cyclic redundancy check) or other reliable means for detecting message errors, if any.

Time-Varying Parameter: A number that changes over time and may optionally indicate the actual clock time at the transmitting authenticator device. (NB: This is included to allow intended receiver 112 (e.g., a terminal or data center and/or complex of machinery) to detect “replay” of previously-transmitted messages.)

Time-Varying Challenge: An unpredictable number that is issued by the intended receiver 112 to be included in the encrypted or cryptographic response so as to prevent “replay” of old messages.

Alternatively, the transmittable data can consist of the captured fingerprint image, itself, or a biometric template obtained from the fingerprint image. In any of these cases, the data is converted into a set of audio tones by modulating the audio signal to represent the binary data. This technique is well known to the art as “modem technology”, for example, as taught in U.S. Pat. No. 4,425,665 to Stauffer, and many others. Additionally, other biometrics can be used, such as a voiceprint or an electrocardiogram, assuming requisite input electronics and input feeds.

Now referring to FIG. 2B, a version of the invention is shown which does not use a fingerprint sensor user authentication. This version operates simply when actuated by one or more push button actuators, such as in FIG. 2A. In this version of the invention, push button operation makes the device essentially a simple actuator, either with separate security features or no security features at all (depending on the application and configuration thereof). NB: As a counterpoint, the simple push button(s) version of the present invention can also be implemented with a basic, push button-implemented security feature by configuring it with the capability to provide a Personal Identification Number (PIN) authentication means for authenticating the user attempting to access the token device. Transmission of the highly directional signal of the present invention is done by RF transmitter 117.

FIG. 3 shows one typical version of a non-directional transmitter (essentially an “isotropic emitter” or “isotropic radiator”, which broadcasts a signal in all directions). The “360° broadcast” characteristics and virtually “spherical” signal output footprint of non-directional transmitters like this, make “isotropic radiators” not amenable to many applications targeted by the present invention. This omnidirectional radiator is shown to point out the typical (restrictive) state-of-the-art in transmitters.

FIG. 4 depicts a directionally-oriented antenna and transceiver which employs a curved reflector to focus a signal beam. In this microwave case or near-microwave case, the curved reflector (shown) helps to direct and propagate signals in a narrow beam, but other “equifinal” signal narrowing and signal propagation techniques can be used. NB: Reduced beamwidth signals propagated by the directional antenna and transceiver of the present invention—plus an optional reflector provides a signal beam with a 10°-15° wide beamwidth, measured between ˜2-feet and ˜12-feet (the “target” distance) from an intended receiver. (Details are entirely dependent on implementation and configuration.)

FIG. 5 shows a signal direction and signal strength plot of an antenna power radiation footprint typical to non-directional antennas, i.e., antennas which are not amenable to use in the present invention.

FIG. 6 is a counterpoint to FIG. 5. FIG. 6 depicts a signal direction and strength plot of the highly directional signal propagation characteristics of the present invention. It can be observed in this case, that a signal beamwidth of only 10°-15° is shown.

FIG. 7 shows a picture of a user's finger (after self-authentication) pressing onto fingerprint sensor 104 aboard token 106. The user is performing this action in order to transmit data and information to an intended receiver (via highly directional RF message transmission signals in signal wave front 126). Transmission from the token transceiver and antenna to the intended transceiver can occur either automatically after user authentication, or can occur when the authenticated user presses a transmit button (not shown), depending on implementation details. To assist an authenticated user undertaking “token aiming”, a guiding illumination beam 123 can be sent out from an light source, light source 122. Source 122 either a collimated laser light source (comparable to a laser “pointer”), or a focused non-laser light source. After user authentication is complete, token 106 is enabled and capable of transmitting highly directional signals to intended transceiver 112 (or other intended transceiver) via radio frequency waves, or other transmission modality capable of transferring signal intelligence (e.g., sonic signals, etc.).

FIG. 8 depicts transmissions from an electronic token 106, to an intended transceiver target 112. Furthermore, FIG. 8 shows a data path from the token 106 to the transceiver target 112, plus also again shows beam 123 aimed at (i.e., “targeted on”) the intended transceiver 112. FIG. 8 also depicts a highly directional RF message transmission signal wave front 126 directionality heading from the token to the intended transceiver 112. Transmissions by RF transmitter 117 are initiated generally by push button and/or automatically after authentication.

FIG. 9 depicts reception of a signal in token 106, from an intended receiver 112. Also shown is the receiving data path, which triggers illumination of a ‘Carrier-detect’ LED. Once the user has authenticated to their token, e.g., then the token transmits the user identification data to the intended receiver 112, which subsequently acknowledges the receipt of the transmission by sending a signal to the token 106 to initiate handshaking. Alternatively, the intended receiver 112 can be polling out to notify incoming tokens that it is available. When the token 106 detects the presence of a polling signal from the intended receiver 112, it can light the Carrier Detect LED 124, as part of the process of helping the user optimally aim the token 106. (Details are dependent on implementation and configuration and applications.) It is important to note, Carrier-detect LED 124 lights to notify the user of receipt of intended transceiver signals detected by RF receiver 119 aboard the token. Alternatively, or other modalities of notifying the user of detection of received carrier from an intended transceiver can be used, e.g., a sound from a sound (audio) generator can be used; a vibration from a vibration generator can be used; etc., depending on details of configuration and implementation.

It is important to note, the terms “transceiver”, “receiver” “intended transceiver”, and “intended receiver” are generally are sometimes used interchangeably. Details of implementation and configuration make specifics of signal processing (i.e., data sources; data sinks; messaging dialogues and interactions between token(s) and one or more intended transceiver(s); single and multiple processing of messages; etc.) vary from one product version to another; from one system implementation to another; and from one application to another. This should be obvious and easily understood by those skilled in the arts directly and indirectly related to the present invention.

Based on the foregoing, it is readily observed by those skilled in the art, that many variations of the present invention are possible. Accordingly, the literal scope of this patent application and its' claims is not limited only to the disclosed embodiments and configurations disclosed herein.

I claim:

1. A wireless, electronic token apparatus, further comprising:
at least one processor;
at least one token actuator;
a transceiver and antenna designed to propagate highly directional signals to an intended transceiver; and
a power source.

2. The apparatus of claim 1, wherein said at least one token actuator comprises at least one push button.

3. The apparatus of claim 2, wherein said at least one push button actuator is adapted for inputting a user PIN sequence for identifying and authenticating an enrolled authorized user.

4. The apparatus of claim 1, wherein said at least one token actuator comprises at least one device for biometrically authenticating an enrolled authorized user.

5. The apparatus of claim 4, wherein said at least one device for biometrically authenticating said enrolled authorized user further comprises a biometric fingerprint authentication device.

6. The apparatus of claim 4, wherein said at least one device for biometrically authenticating said enrolled authorized user further comprises a biometric voiceprint authentication device.

7. The apparatus of claim 4, wherein said at least one device for biometrically authenticating said enrolled authorized user further comprises a biometric electrocardiogram authentication device.

8. The apparatus of claim 1, wherein said wireless electronic token further comprises a token-aiming light source for aiming and targeting said intended transceiver, further comprising one of a collimated laser light source and a non-laser focused light source.

9. The apparatus of claim 1, wherein said wireless electronic token further comprises carrier detection circuitry for detecting signals transmitted from said intended transceiver to said token, and yet further comprises means for indicating that said signals from said intended transceiver have been detected and received by said wireless electronic token.

10. The apparatus of claim 9, wherein said means for indicating that said signals from said intended transceiver have been detected further comprises at least one of an illuminated LED display and a sound from a sound generator and a vibration from a vibration generator.

11. A method for conducting highly directional wireless communications between a user operated electronic token and an intended transceiver, comprising the steps of:
providing an electronic token including a token transceiver and antenna adapted for highly directional signal propagation;
providing at least one token-aiming device on the exterior of said token for facilitating user token-aiming;
aiming by said user of said token toward said intended transceiver;
pressing a transmit button on said electronic token to transmit said highly directional signal to said intended transceiver and receiving said highly directional signal in said intended transceiver.

12. The method of claim 11, wherein the step of pressing a transmit button to transmit said signal and the step of receiving said signal in said intended transceiver occur only after authentication of an authorized enrolled user.

13. A system for maximizing signal transmission accuracy and security between directional wireless electronic tokens and intended transceivers, comprising:
at least one directional wireless electronic token;
at least one user aiming said at least one token in order to maximize highly directional signal transmission; and
at least one intended transceiver.
